(19) United States
(12) Patent Application Publication
(10) Pub. No.: US 2007/0188869 A1
(43) Pub. Date: Aug. 16, 2007

(54) Oblique parallelogram pattern diffractive optical element

(75) Inventors: Craig First, Arlington, MA (US); Xinbing Liu, Cambridge, MA (US)

Correspondence Address: RATNERPRESTIA, P.O. BOX 980, VALLEY FORGE, PA, 19482, US

(73) Assignee: Matsushita Electric Industrial Co., Ltd.

(21) Appl. No.: 11/351,972

(22) Filed: Feb. 10, 2006

(51) Int. Cl. G02B 5/18; B23K 26/38

(52) U.S. Cl. 359/573

(57) ABSTRACT

A diffractive optical element (DOE), including a substrate formed of a substantially transparent material having a substrate index of refraction. The substrate includes a first transmission face that is substantially planar and a second transmission face that is substantially parallel to the first transmission face. The second transmission face includes an array of non-rectangular pixels that form a complete tiling over the functional area of this face. For each of the non-rectangular pixels of the array, the phase shift of light transmitted through the substrate between the transmission faces is approximately equal to one of a set of predetermined phase shifts.

### FIELD OF THE INVENTION

The present invention concerns improved designs for diffractive optical elements (DOE's) as well as systems and methods for manufacturing these DOE's. In particular, these improved designs utilize non-rectangular pixels to allow for simplified formation of optical patterns that are not easily laid out on a square grid.

### BACKGROUND OF THE INVENTION

Diffractive Optical Elements (DOE) are a type of optical element with a surface relief profile that changes the phase of the light passing through it. One example of an application for which a DOE may be used is as a beam splitter. The DOE may be designed for a particular array of output beams. The desired pattern of the DOE is calculated based on the theory of diffraction so that constructive interference causes the intensity of the transmitted light to have a desired set of bright spots (i.e. the array of output beams). Other examples of DOE's include: Fresnel lenses, gratings, computer-generated (phase-only) holograms, micro-lens arrays and beam shaping elements.

DOE's achieve their desired diffracted patterns due to the different phase shifts of the incoming beam that occur as the light is transmitted through the various different thicknesses of the DOE patterns based upon the index of refraction of the DOE substrates and the wavelength of the incident beam.

A DOE pattern is usually generated in photoresist using either a grayscale mask lithography process or a multiple binary mask lithography process. Alternatively, DOE patterns may be directly written using a laser writer. The exposed pattern of the photoresist is then developed and either the developed pattern in the photoresist itself can be used to diffract an incoming beam, or the exposed pattern in the photoresist may be transferred into the underlying substrate using an anisotropic etching procedure. If the pattern is transferred into the substrate then the substrate acts as the diffractive structure.

Existing beam splitter DOE's are currently designed and fabricated on a rectangular (often square) orthogonal grid pattern, such as exemplary square pixel DOE pattern 100, shown in FIG. 1. The surface relief pattern of this exemplary DOE is made up of a collection of rectangular (square) forms of varying heights to produce the phase mask. The shades of gray in FIG. 1 represent the varying heights of the surface profile and serve to distinguish individual pixels 102 in square pixel DOE pattern 100.

Because the DOE pattern is formed in a rectangular grid, the resulting diffracted pattern produced by the DOE is also arrayed upon rectangular coordinate output grid 200, as illustrated in FIG. 2. Each of the points 202 illustrates the location of a potential output beam in the far field of a DOE. Although a DOE may be designed to produce output beams at only a selected subset of these points, a DOE pattern formed in a rectangular grid can produce beams only at points 202 of upon rectangular coordinate output grid 200. Thus, in methods to design a DOE with a rectangular DOE pattern for a particular desired diffracted pattern, the desired diffracted pattern must be able to fit onto the rectangular pattern grid spacing output of the DOE.

This may limit the design possibilities for the diffracted pattern since the desired pattern spacing (bright orders 400, shown in FIG. 4) must be a multiple of the lowest common denominator of the underlying diffracted grid spacing (dark orders 402). An example of this is shown in FIG. 4. Additionally, even when the pattern may be fit to the rectangular output grid, the pattern may require a large number of points to fit the desired pattern, which, in turn, may require a large number of pixels in the DOE pattern to form the desired array of output beams.

The present invention involves improved designs utilize non-rectangular pixels to allow for simplified formation of optical patterns that are not easily laid out on a rectangular grid and may allow for unit cells made up of fewer pixels in periodic DOE structures. Thus, large periodic patterns in devices such as ink jet nozzles may be manufactured by a laser machining system with fewer ‘step and repeats’ iterations, without using a larger DOE.

### SUMMARY OF THE INVENTION

An exemplary embodiment of the present invention is a diffractive optical element (DOE), including a substrate formed of a substantially transparent material having a substrate index of refraction. The substrate includes a first transmission face that is substantially planar and a second transmission face that is substantially parallel to the first transmission face. The second transmission face includes an array of non-rectangular pixels that form a complete tiling over the functional area of this face. For each of the non-rectangular pixels of the array, the phase shift of light transmitted through the substrate between the transmission faces is approximately equal to one of a set of predetermined phase shifts.

Another exemplary embodiment of the present invention is a DOE, including a substrate formed of a substantially transparent material and a diffractive structure formed of photoresist having a photoresist index of refraction. The substrate includes a first surface and a second surface that is substantially parallel to the first surface, and the diffractive structure is formed on the second surface of the substrate. The diffractive structure includes an array of non-rectangular pixels that form a complete tiling over a functional area of the second surface of the substrate. For each of the non-rectangular pixels of the array, the thickness of the diffractive structure is approximately equal to one of a set of predetermined thicknesses.

A further exemplary embodiment of the present invention is a laser writing system with non-orthogonal axes for laser machining a workpiece. The laser writing system includes: a laser source to generate a laser beam; coupling optics to couple laser light to a beam spot on the workpiece; a workpiece holder to hold the workpiece; and positioning means coupled to the workpiece holder to scan the beam spot over the workpiece. The positioning means includes an X translation stage to move the workpiece holder along an X axis and a Y translation stage to move the workpiece holder along a Y axis. The X axis and the Y axis are substantially orthogonal to the direction of propagation of the laser beam at the beam spot. However, the X axis is neither parallel nor perpendicular to the Y axis.

An additional exemplary embodiment of the present invention is a laser writing system with non-orthogonal axes for laser machining a workpiece. The laser writing system includes: a laser source to generate a laser beam; coupling optics to couple laser light to a beam spot on the workpiece; scanning optics to scan the beam spot on the workpiece along the X axis; a workpiece holder to hold the workpiece; and a Y translation stage coupled to the workpiece holder to move the workpiece holder along the Y axis. The positioning means includes an X translation stage to move the workpiece holder along an X axis and a Y translation stage to move the workpiece holder along a Y axis. The X axis and the Y axis are substantially orthogonal to the direction of propagation of the laser beam at the beam spot. However, the X axis is neither parallel nor perpendicular to the Y axis.

Yet another exemplary embodiment of the present invention is a method for manufacturing a DOE having a predetermined pattern of parallelogram-shaped pixels, using a laser writing system with non-orthogonal X and Y axes. A DOE workpiece is mounted in a workpiece holder of the laser writing system. A laser beam is generated using a laser source of the laser writing system. The laser beam is directed to a beam spot on a surface of the DOE workpiece using optics of the laser writing system. The beam spot is then scanned across a functional area of the surface of the DOE workpiece along the X axis. The workpiece holder of the laser writing system is moved using a Y translation stage of the laser writing system such that the beam spot is stepped along the Y axis. The X axis and the Y axis are substantially orthogonal to a direction of propagation of the laser beam at the beam spot. However, they are neither parallel nor perpendicular to each other. The fluence of the laser beam at the beam spot is modulated as the beam spot is scanned to form the predetermined pattern of parallelogram-shaped pixels of the DOE in the functional area on the surface of the DOE workpiece. The scanning, stepping, and modulating steps are repeated until the beam spot has been scanned over the entire functional area on the surface of the DOE workpiece.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawing are the following figures:

FIG. 1 is a grey-scale graph illustrating a prior art, square pixel pattern for a diffraction optical element (DOE).

FIG. 2 is top plan drawing illustrating a square grid of points that may be illuminated by a prior art DOE using a square pixel pattern, such as the pattern shown in FIG. 1.

FIG. 3 is a top plan drawing illustrating an exemplary hole pattern of an ink jet nozzle that may be formed using a laser drilling system.

FIG. 4 is a top plan drawing illustrating a method of laying out a portion of the exemplary hole pattern of FIG. 3 using the prior art square grid of points of FIG. 2.

FIG. 5 is a grey-scale graph illustrating an exemplary non-rectangular DOE pixel pattern according to the present invention.

FIG. 6 is top plan drawing illustrating an exemplary non-rectangular grid of points that may be illuminated by an exemplary DOE using a non-rectangular pixel pattern, such as the exemplary pattern shown in FIG. 5, according to the present invention.

FIG. 7 a top plan drawing illustrating an exemplary method of laying out a portion of the exemplary hole pattern of FIG. 3 using the exemplary non-rectangular grid of points of FIG. 6, according to the present invention.

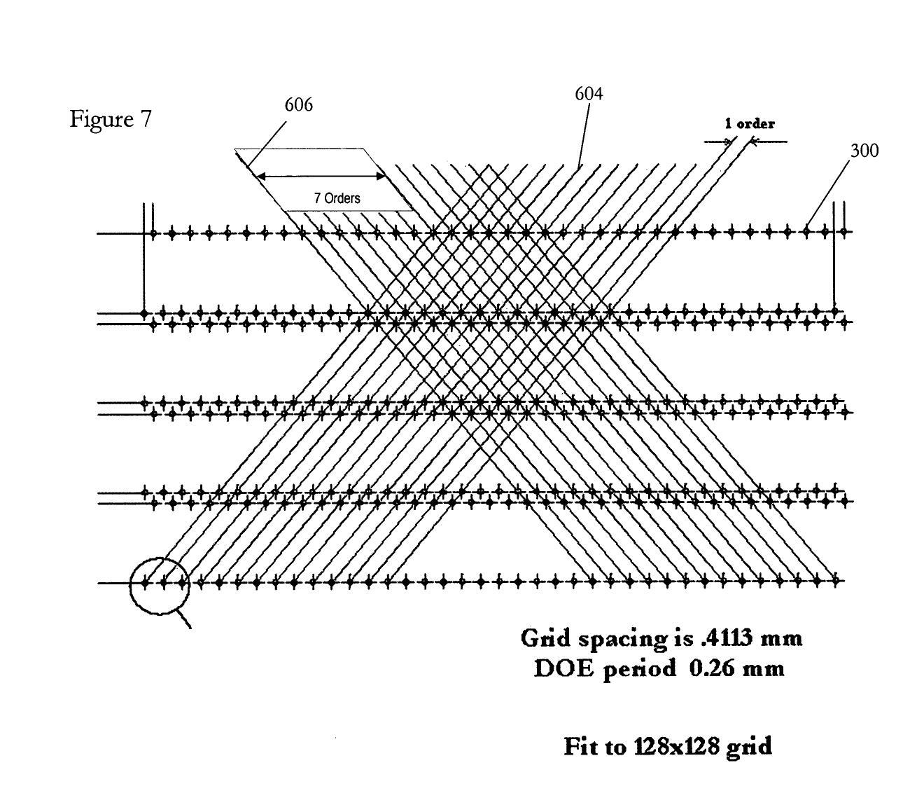

FIGS. 8A and 8B are side plan drawings illustrating exemplary laser machining systems according to the present invention.

FIGS. 9A and 9B are top plan drawings illustrating exemplary workpiece positioning means of the exemplary laser machining systems of FIGS. 8A and 8B, respectively.

FIG. 10 is a flow chart illustrating an exemplary method of manufacturing a DOE with a non-rectangular pixel pattern according to the present invention.

### DETAILED DESCRIPTION OF THE INVENTION

An exemplary embodiment of the present invention is a DOE fabricated with a non-rectangular pattern, such as an oblique parallelogram pattern, a triangular pattern, or a hexagonal pattern, to tile the functional area of the DOE surface. In many designs the non-rectangular pixels of the DOE may be congruent to one another. However, it is contemplated that exemplary DOE's utilizing other pixel patterns that may be used as well, as long as the pixels are selected to tile the surface of the functional area. The use of these non-orthogonal surface relief patterns provides a resulting diffracted pattern that is arrayed on a non-orthogonal grid and, thus, allows for greater design flexibility for the array of output beams.

An exemplary DOE according to the present invention includes a substrate formed of a substantially transparent material, such as glass, fused silica, quartz, silicon, sapphire, acrylic, silicone, polystyrene, polycarbonate, a cyclic olefin polymer, a cyclic olefin copolymer, or a perfluorocyclobutane polymer.

In operation, light of a preselected wavelength is transmitted through an exemplary DOE beam splitter from one face to another and phase differences caused by the pixel pattern lead to the desired output array of beams. One of these faces of the substrate is desirably substantially planar. An anti-reflection coating may be formed on this face of the substrate to reduce loses. The other transmission face is substantially parallel to the first face. This second transmission face includes the array of non-rectangular pixels to generate the desired phase differences. This array of non-rectangular pixels desirably forms a complete tiling over the functional area of this face of the DOE.

These pixels in the functional area of the DOE may be formed in a number of ways. For example, the pixels may be etched into the substrate material, using procedures such as three dimensional photolithographic techniques, laser ablation techniques, or etching techniques, including reactive ion etching and plasma etching. Alternatively, the pixels may be formed of material grown on the substrate surface, using procedures such as three dimensional photolithographic or laser assisted chemical vapor deposition techniques. It is also contemplated that the pixels may be formed by controllably altering the index of refraction of the substrate material within the pixels. Such localized alteration of refractive indices may be accomplished using ultrafast laser machining of the substrate material.

In each of the non-rectangular pixels of the array, the phase shift of the light transmitted through the substrate between the transmission faces is approximately equal to one of a set of predetermined phase shifts. In a simple, binary DOE design this set of phase shifts may have only two values, 0° and 180°, for example. Alternatively, a larger number of potential phase shifts may be desired. The phase shifts may desirably be equally spaced to simplify calculation of the resulting output beam array.

In exemplary DOE's in which the phase shift is due to variations in the thickness of the substrate material, the index of refraction of the substrate material and the wavelength of the light for which the DOE is designed determine the desired heights of the surface relief of the pixels. Similarly, the thickness of the photoresist, the index of refraction of the photoresist material and the design wavelength of the DOE determine the desired heights of the surface relief of photoresist pixels. For pixels formed by altering the refractive index of the substrate material it is the thickness of the altered portion, the change in refractive index and the design wavelength that determine the desired DOE pattern.

Typically, the phase shifts are kept within a range of one period, i.e. 0°-360°. Thus, in exemplary DOE's in which the phase shift is due to variations in the thickness of the substrate material, the difference between the smallest thickness and the largest thickness of the substrate material in the DOE is less than the predetermined wavelength of light divided by the substrate index of refraction minus one (i.e. λ/(nₛ−1)). Similarly, in exemplary DOE's in which the phase shifts are caused by a photoresist layer, the difference between the smallest thickness and the largest thickness of the photoresist layer is less than the predetermined wavelength of light divided by the index of refraction of the photoresist minus one (i.e. λ/(nₚ−1)).

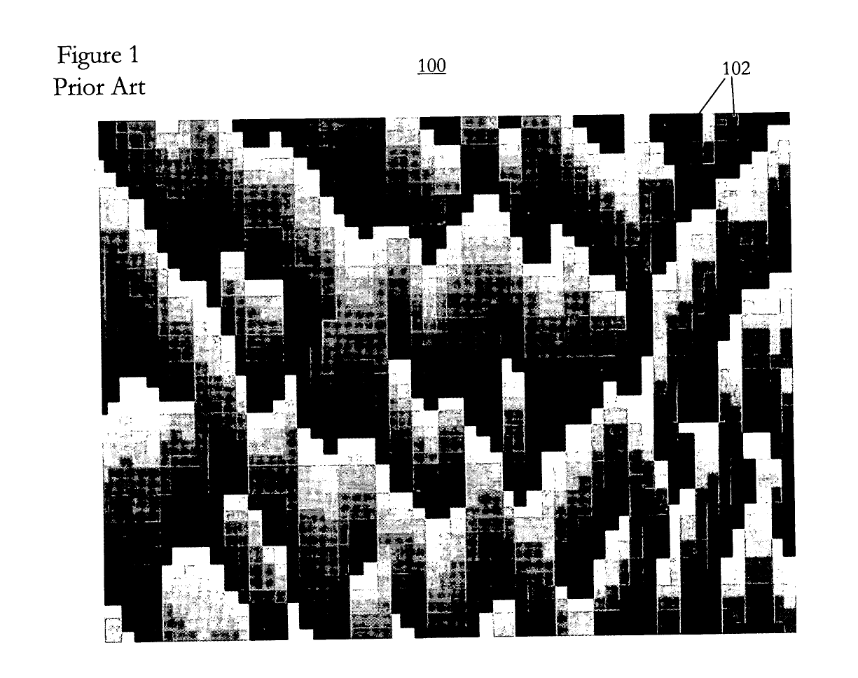

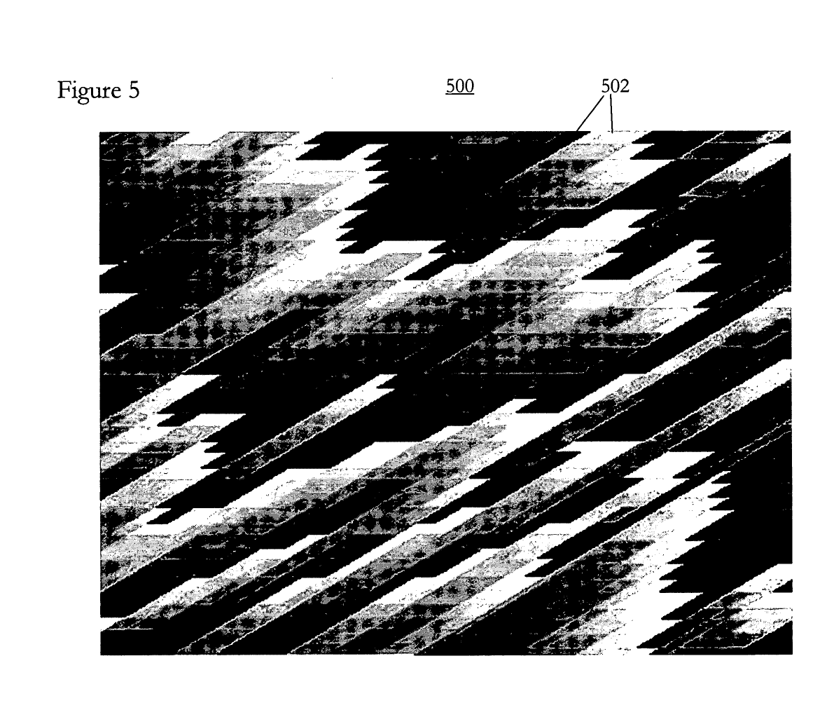

FIG. 5 illustrates an exemplary DOE pixel pattern according to the present invention. Exemplary DOE pattern 500 is formed of congruent oblique-parallelogram-shaped pixels 502. As in FIG. 1, the gray scale coloring of oblique-parallelogram-shaped pixels 502 represents variations in height. Since the geometry of a parallelogram array is inherently different than a square or rectangular array it may enable diffracted beam spacing that would not be possible using a rectangular grid.

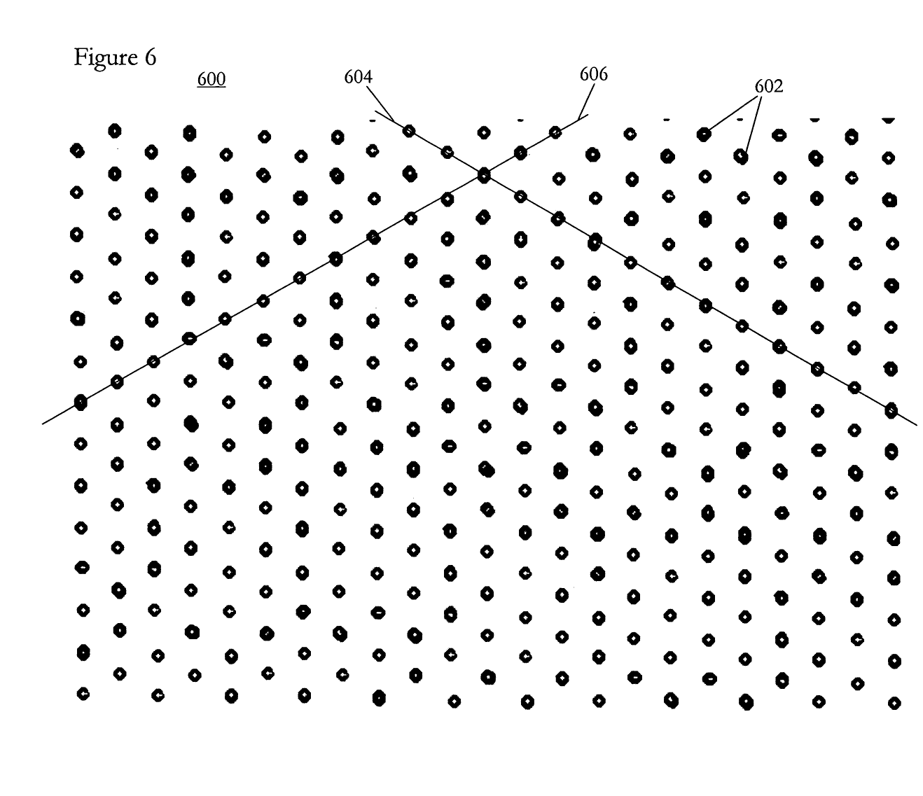

Depending upon the angles chosen for the parallelogram, there are many possible output patterns. Based upon the desired pattern the optimal angular orientation could be determined using basic geometric mathematics. For example, in exemplary DOE pixel pattern 500, a 60° angle is used for the parallelogram skew. The resulting output grid of points is shown in FIG. 6. It may be noted that the output grid associated with a 60° angle parallelogram DOE pattern, such as exemplary DOE pattern 500, may be used to form a hexagonal array of output beams. However, as only two dimensions are necessary to define the array of output beams formed by a DOE beam splitter, points 602 of exemplary output grid 600 may be identified using non-orthogonal X-axis 604 and Y-axis 606. Because the array may be defined using an X-Y grid, albeit skewed to a particular angle, a standard coordinate system may be employed to design and designate pixels.

For certain applications, having the ability to layout the desired pattern on an oblique grid may allow for fewer design constraints compared to an orthogonal array.

Another advantage of this exemplary embodiment is a reduced total coordinate grid necessary for output beams. Reducing the number of coordinates needed, may also reduce the computer simulation run time used when designing a DOE, which may in turn help with rapid prototyping and reduced design turnaround time for manufacturing design changes.

In certain instances the more efficient layout of output beams on an oblique grid may also allow for a smaller DOE period, potentially allowing more periods to be illuminated for a given input beam size. Having more periods illuminated may allow for better defined diffracted output beams. Alternatively, the use of a more efficient layout pattern may allow for more repetitions of the periodic pattern of output beams to be formed simultaneously. Increasing the repetitions formed simultaneously may allow for increased productivity and/or fewer step-and-repeat operations. The reduction of step-and-repeat operations may be particularly useful for laser machining of repetitive structures due to the associated potential for misalignment with each step.

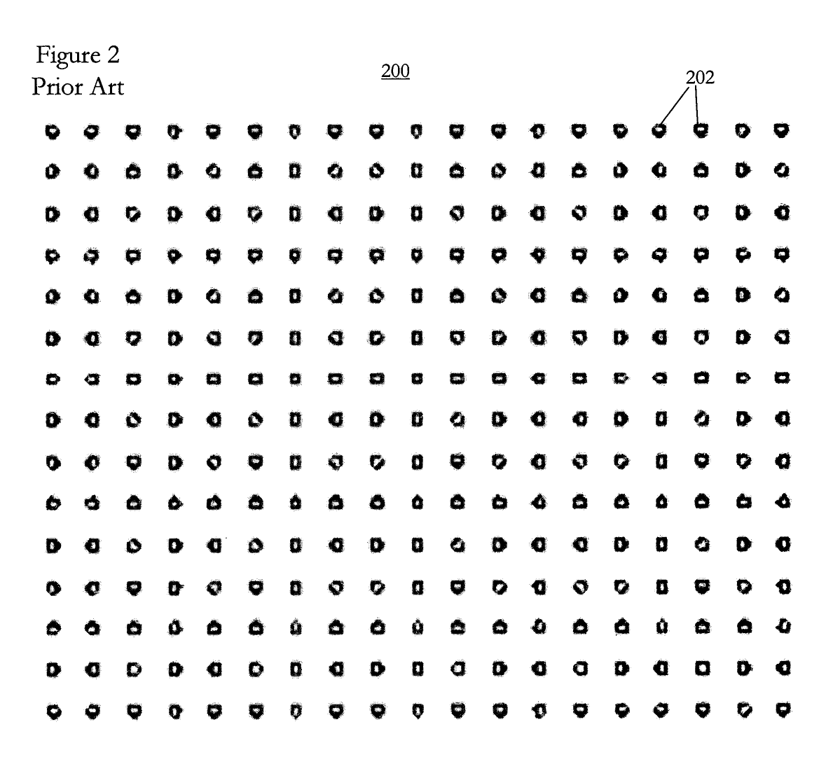

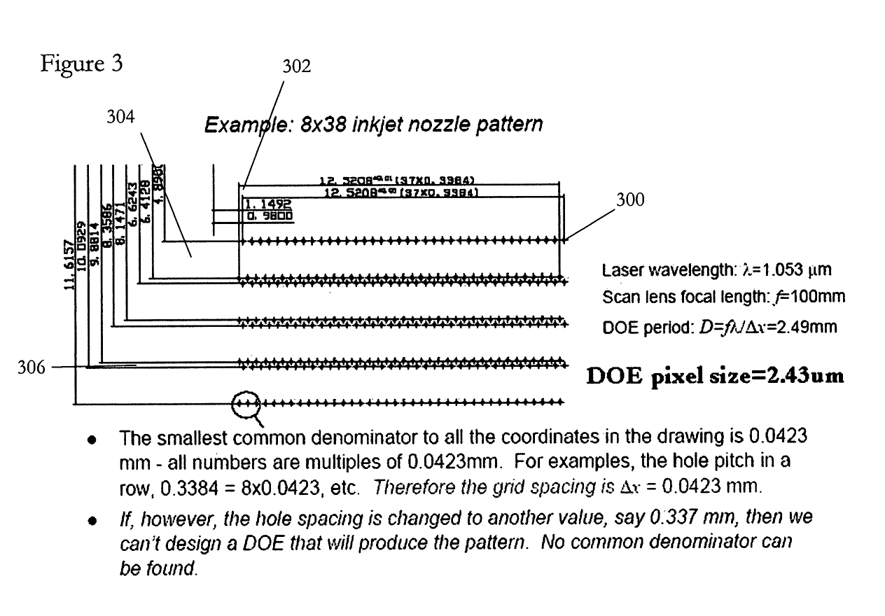

For example, FIG. 3 illustrates a desired pattern of holes 300 to be drilled to form an exemplary ink jet nozzle. Because of the large number of holes involved it is desirable to drill as many of these holes at once in parallel as practical. As discussed above, DOE's fabricated with a rectangular pattern to create the surface relief profile for the diffractive element, such as DOE pattern 100 in FIG. 1 result in a diffracted pattern that is also arrayed upon square coordinate output grid 200 as shown in FIG. 2. Thus, to design a DOE beam splitter for use in fabricating this exemplary ink jet nozzle the spacing of holes 300 on an orthogonal X-Y coordinate system is needed. The X spacing 302 (0.1692 mm) is regular throughout the pattern. There are, however two Y spacings, 304 (1.5228 mm) and 304 (0.2115 mm).

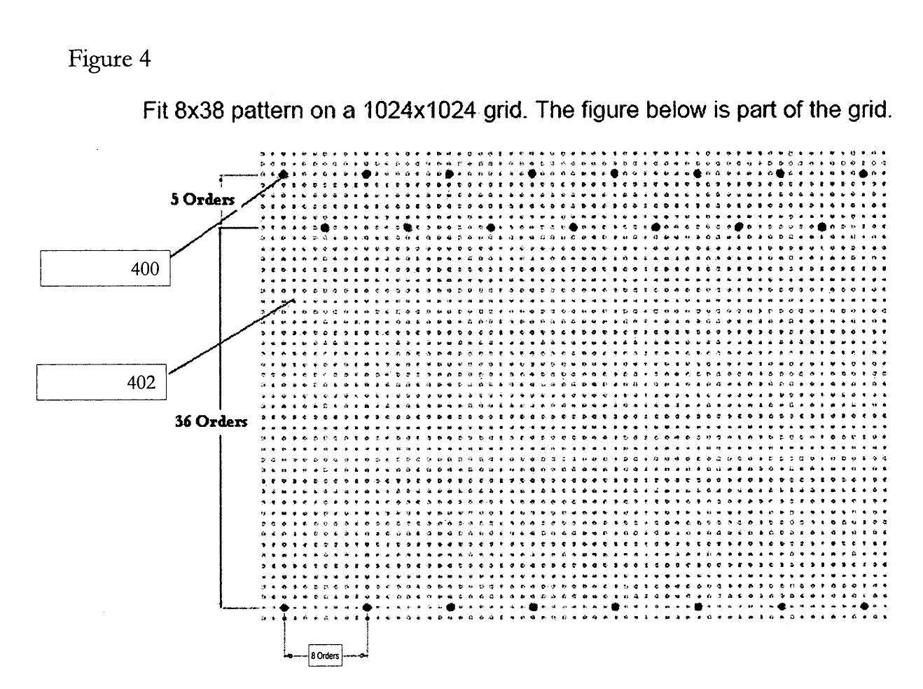

As shown in FIG. 4, this pattern may be set out on a square X-Y grid with a spacing of 0.0423 mm between the points. A DOE pattern may then be formed so that the transmitted light constructively interferes to form output beams at each of the bright orders 400, and destructively interferes at each of the dark orders 402. X spacing 302 corresponds to 4 orders (8 orders within each row with an offset of 4 orders between rows), Y spacing 304 corresponds to 5 orders, and Y spacing 306 corresponds to 36 orders in this grid. To achieve the desired number of holes, this pattern must be fit to a 1024×1024 grid and the fabricated DOE phase mask period is 2.49 mm.

Designing a DOE pattern for the same inkjet design using the exemplary oblique parallelogram grid of FIG. 6, leads to a different result. In this exemplary grid, the holes align more regularly with X spacings of 0.4113 mm between the closer holes and 2.8791 mm between the more distant holes and Y spacings of 0.4113 mm. This translates into 1 and 7 orders along X axis 604 and 1 order along Y axis 606. Thus, the ink jet nozzle pattern may be fit by a 128×128 grid array. The grid spacing is also much larger for the exemplary parallelogram pixel patterned DOE than in the square pixel patterned DOE (0.4113 mm vs. 0.0423 mm). Thus, the fabricated parallelogram pixel patterned DOE phase mask may be designed to have a period of only 0.26 mm, allowing for more periods to be illuminated for a given beam size, thereby helping to increase the output beam definition for more precise machining.

Fabricating an exemplary parallelogram pixel patterned DOE may by a number of methods. For example, the design may be formed using a grayscale mask that incorporates an oblique parallelogram pixel pattern to expose a photoresist layer. The exposed photoresist may then be developed to form the desired pixel pattern in the photoresist. Alternatively, the developed photoresist, and the DOE substrate, may be anisotropically etched to transfer the pixel pattern onto the substrate material.

Alternatively, a direct writing method such as using a laser writer may be used to form an oblique parallelogram pixel pattern on the DOE. The software of laser writers is typically designed to write patterns using orthogonal X-Y axes. The laser writer software may by modified to write parallelogram patterns using standard orthogonal X-Y motion, however, by building up the larger parallelogram pattern pixels by exposing the smaller individual exposure spots, similar to the manner in which a computer printer creates a diagonal line using X-Y motion.

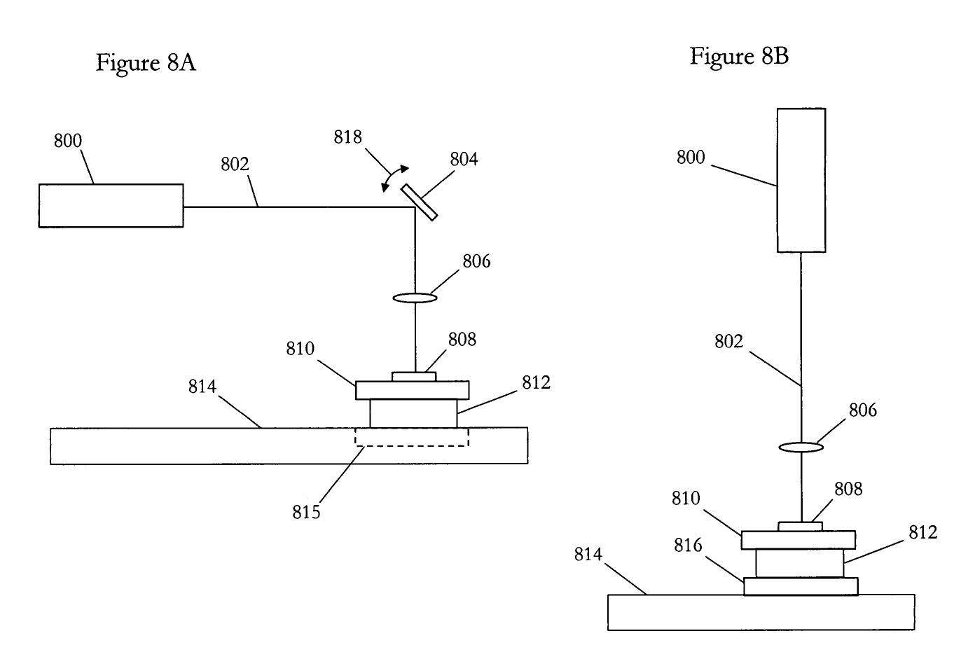

FIGS. 8A and 8B illustrate exemplary laser writing systems that may simplify fabrication of DOE's having non-rectangular pixel patterns. These exemplary laser writing systems are arranged to operate along non-orthogonal axes for laser machining a workpiece. It is noted that, although the exemplary embodiments of FIGS. 8A and 8B are described in terms of their use in the fabrication of DOE's having non-rectangular pixel patterns, it is contemplated that these exemplary laser writing systems may be used for numerous other laser machining procedures in which non-orthogonal symmetries may exist.

The exemplary laser writing system of FIG. 8A includes laser source 800 to generate laser beam 802; coupling optics 806 to couple laser light to a beam spot on the workpiece; scanning optics 804 to scan the beam spot on the workpiece along an X axis; workpiece holder 808 in which the workpiece is held; and Y translation stage 810 coupled to workpiece holder 808 to move the workpiece holder along a Y axis. The X and Y axes are both substantially orthogonal to the direction of propagation of laser beam 802 at the beam spot, but are neither parallel nor perpendicular to each other. Rotation stage 812 may be coupled between the laser writing system base 814 and Y translation stage 810 to allow the angle between the X and Y axes to be varied as desired for a given job. Rotation stage 812 is described in more detail below.

Laser source 800 may be a continuous wave (CW) or a pulsed laser source. Laser source 800 desirably includes a fluence controller to control the fluence of the laser beam as the beam spot is scanned over the workpiece. Fluence control may be achieved by controlling the average power of laser beam 802 either by directly varying the output power of laser source 800 or by using a variable attenuator coupled along the beam path. Alternatively, the fluence may be controlled by changing the size of the beam spot formed on the surface of the workpiece or by varying the scan speed of the beam spot across the workpiece.

Scanning optics 804 include a scan mirror, or prism, that may pivot as shown by arrows 818 to sweep laser beam 802 though a range of angles to provide the X-axis scan of the beam spot over the surface of the workpiece. Additionally, scanning optics 804 may desirably include a telecentric scan lens to align laser beam 802 to be substantially normally incident to the surface of the workpiece throughout the travel of the scanning mirror. It is noted that laser writing system base 814 may additionally include X translation stage 815 (shown in phantom) coupled to rotation stage 812. Alternative X translation stage 815 may be used to initially align the beam spot on the surface of workpiece 808. It may also be used to step the workpiece in the X direction, thereby allowing the exemplary laser writing system to be used for machining structures with length in the X direction greater than the length of a scan line produced by a single sweep of scanning optics 804.

Coupling optics 806 may desirably focus the laser light at the beam spot on the workpiece and may include additional components to control the polarization of laser beam 802. Focusing of the laser beam at the beam spot may be controlled by moveable lenses or other optical components within coupling optics 806 and/or may be controlled by moving workpiece holder 808 along the Z axis, i.e. substantially parallel to the direction of propagation of laser beam 802 at the beam spot. The workpiece holder may be moved along Z axis using a Z translation stage (not shown) coupled to the workpiece holder.

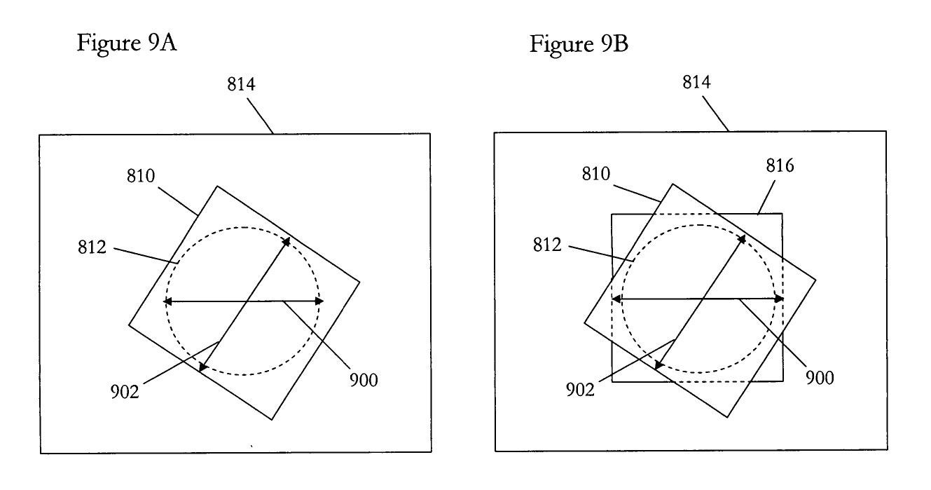

FIG. 9A shows a top view of Y translation stage 810 and rotation stage 812 to illustrate an exemplary relationship of X axis 900 and Y axis 902 that may be used by the exemplary laser writing system of FIG. 8A. X axis 900 is the axis along which the beam spot is scanned over the surface of workpiece 808 by scanning optics 804 during operation of the exemplary laser writing system of FIG. 8A and Y axis 902 is the axis along which workpiece 808 is stepped by Y translation stage 810 to step the beam spot from the end of one scan line to the next. Rotation stage 812 may be used to rotate Y translation stage 810, thus varying the angular relationship between X axis 900 and Y axis 902.

FIG. 8B illustrates an alternative exemplary laser writing system with non-orthogonal axes. Like numbered elements are similar to those in FIG. 8A. In the exemplary embodiment of FIG. 8B, X translation stage 816 moves workpiece holder 808 along the X axis to scan the beam spot over the workpiece in the X direction, rather than scanning optics 804 as in the exemplary embodiment of FIG. 8A. It is noted that rotational stage 812 is desirably mounted between X translation stage 816 and Y translation stage 810 in this exemplary embodiment. Additionally, it is noted that coupling optics 806 may include a fiber optic link in this embodiment. FIG. 9B shows a top view of X translation stage 816, Y translation stage 810, and rotation stage 812 to illustrate how they may be used to create an exemplary relationship of X axis 900 and Y axis 902 in the exemplary laser writing system of FIG. 8B. As described above regarding the exemplary system of FIGS. 8A and 9A, rotation stage 812 may be used to rotate Y translation stage 810, thus varying the angular relationship between X axis 900 and Y axis 902 in the exemplary system of FIGS. 8B and 9B.

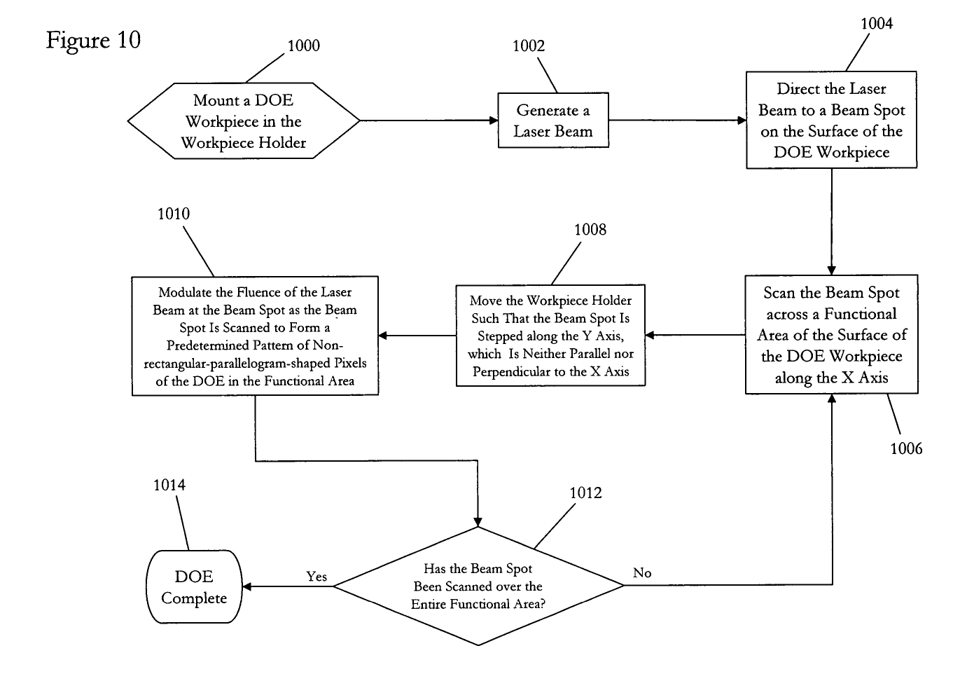

FIG. 10 illustrates an exemplary method that may be used to manufacture an exemplary DOE having a predetermined pattern of parallelogram-shaped pixels according to the present invention. This exemplary method may desirably use a laser writing system with non-orthogonal X and Y axes, such as the exemplary laser writing systems of FIG. 8A and 8B.

The DOE workpiece is mounted in a workpiece holder of the laser writing system, step 1000. The DOE workpiece may have a photoresist layer formed on its surface before it is mounted. The DOE workpiece may be mounted such that a predetermined scan line the DOE workpiece is substantially aligned to the X axis of the laser writing system. A rotation stage coupled to the Y translation stage of the laser writing system may be used to orient the Y axis at a predetermined angle relative to the X axis at this point as well.

A laser beam is generated using the laser source of the laser writing system, step 1002. The laser source of the laser writing system may be either a CW laser source or a pulsed laser source. If a pulsed laser source is used then a pulsed laser beam is generated.

The laser beam is directed to a beam spot on a surface of the DOE workpiece using optics of the laser writing system, step 1004. The beam spot may be focused using the optics of the laser writing system such that the beam spot has a predetermined diameter of the surface of the DOE. Additionally, the cross section of the laser beam may be shaped using the optics such that the beam spot has a predetermined shape. For example, a beam spot sized and shaped to match the size and shape of the parallelogram pixels of the DOE may be useful.

The beam spot is scanned across a functional area of the surface of the DOE workpiece along the X axis, step 1006. The workpiece holder of the laser writing system may desirably be moved using an X translation stage of the laser writing system to scan the beam spot across the functional area of the surface of the DOE workpiece along the X axis. Alternatively, the beam spot may be moved using scanning optics of the laser writing system to scan the beam spot across the functional area along the X axis. The scanning of the beam spot across the functional area along the X axis may be continuous or it may be done in steps. Stepping the beam spot may be desirable if a pulsed laser source is used to generate the laser beam. The stepping of the beam spot may be synchronized with the pulsing of the pulsed laser source.

The workpiece holder of the laser writing system is moved, step 1008, using a Y translation stage of the laser writing system such that the beam spot is stepped along the Y axis at the end of each scan along the X axis. The X axis and the Y axis are desirably arranged such that they are substantially orthogonal to the direction of propagation of the laser beam at the beam spot and are neither parallel nor perpendicular to each other.

The fluence of the laser beam is modulated at the beam spot as the beam spot is scanned to form the predetermined pattern of parallelogram-shaped pixels of the DOE in the functional area on the surface of the DOE workpiece, step 1010. If the laser source of the laser writing system is a CW laser source, then the fluence at the beam spot may be modulated by varying the power of the CW laser beam or by varying the scan speed along the X axis. If the laser source of the laser writing system is a pulsed laser source, then the fluence at the beam spot may be modulated by varying the pulse power of the laser beam or by varying the scan speed along the X axis if a continuous scan is used. If the beam spot is stepped along the X axis, then the step time may be varied such that a predetermined number of laser pulses may be incident at each step location. Alternatively, the fluence may be varied by varying the beam spot size, but this method of varying the fluence may be difficult to control.

The desired fluence depends on the laser machining process by which predetermined pattern of parallelogram-shaped pixels of the DOE are to be formed. Exemplary laser machining processes that may be used include: laser ablation of material of the DOE workpiece; deposition of material on the surface of the DOE workpiece using a laser assisted chemical vapor deposition process; exposing a photoresist layer on the surface of the DOE workpiece; and changing the refractive index of material of the DOE workpiece via ultrafast laser irradiation. If the laser writing system is used to expose a pattern of parallelogram-shaped pixels in a photoresist layer rather than being used to perform one of the other laser machining methods, the photoresist layer may be developed to form the predetermined pattern of parallelogram-shaped pixels of the DOE in the photoresist layer. Alternatively, the developed photoresist layer may form a scaled pattern of parallelogram-shaped pixels in the photoresist layer. This scaled pattern may be transferred to the substrate by etching the photoresist layer and material of the DOE workpiece, thus forming the predetermined pattern of parallelogram-shaped pixels of the DOE in the functional area on the surface of the DOE workpiece.

After each scan and step iteration (steps 1006, 1008, and 1010), it is determined if the beam spot has been scanned over the entire functional area on the surface of the DOE workpiece, step 1012. If the entire functional area has been scanned, then the DOE is complete, step 1014 (except for developing and possibly etching the photoresist layer if a photolithographic process is used). If the entire functional area has not yet been scanned, then steps 1006, 1008, and 1010 are repeated until the entire functional area has been scanned.

The present invention includes a number of exemplary embodiments of DOE's having non-rectangular pixel patterns, as well as exemplary methods of manufacturing such DOE's. Additionally, the present invention includes exemplary laser writing systems that may be used with these exemplary methods. Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A diffractive optical element (DOE), comprising:
a substrate formed of a substantially transparent material having a substrate index of refraction, the substrate including;
a first transmission face that is substantially planar; and
a second transmission face substantially parallel to the first transmission face, the second transmission face including an array of non-rectangular pixels that form a complete tiling over a functional area of the second transmission face;
wherein, for each of the non-rectangular pixels of the array, a phase shift of light transmitted through the substrate between the first transmission face and the second transmission face is approximately equal to one of a set of predetermined phase shifts.

2. The DOE according to claim 1, wherein the substantially transparent material of the substrate is one of glass, fused silica, quartz, silicon, sapphire, acrylic, silicone, polystyrene, polycarbonate, a cyclic olefin polymer, a cyclic olefin copolymer, or a perfluorocyclobutane polymer.

3. The DOE according to claim 1, wherein an anti-reflection coating is formed on the first transmission face of the substrate.

4. The DOE according to claim 1, wherein the non-rectangular pixels of the second transmission face are congruent to one another.

5. The DOE according to claim 4, wherein each of the non-rectangular pixels of the second transmission face is one of a parallelogram, a triangle, or a hexagon.

6. The DOE according to claim 1, wherein:
in each of the non-rectangular pixels of the array, a thickness of the substrate between the first transmission face and the second transmission face is approximately equal to one of a set of predetermined thicknesses; and
each value of the set of predetermined thicknesses corresponds to a respective value of the set of predetermined phase shifts.

7. The DOE according to claim 6, wherein:
the DOE is adapted to be used with a light having a predetermined wavelength;
the set of predetermined thicknesses includes a smallest thickness and a largest thickness; and
a difference between the smallest thickness and the largest thickness is less than the predetermined wavelength of the light divided by a sum of the substrate index of refraction and negative one.

8. The DOE according to claim 1, wherein:
in each of the non-rectangular pixels of the array, a refractive index of the substrate between the first transmission face and the second transmission face is approximately equal to one of a set of predetermined refractive indices;
one value of the set of predetermined refractive indices is the substrate index of refraction; and
each value of the set of predetermined refractive indices corresponds to one value of the set of predetermined phase shifts.

9. The DOE according to claim 1, wherein the set of predetermined phase shifts has two values.

10. The DOE according to claim 1, wherein a difference between each consecutive pair of values in the set of predetermined phase shifts is approximately the same.

11. A diffractive optical element (DOE), comprising:
a substrate formed of a substantially transparent material, the substrate including a first surface and a second surface substantially parallel to the first surface; and
a diffractive structure formed of photoresist on the second surface of the substrate, the photoresist having a photoresist index of refraction;
wherein:
the diffractive structure includes an array of non-rectangular pixels that form a complete tiling over a functional area of the second surface of the substrate; and
for each of the non-rectangular pixels of the array, a thickness of the diffractive structure is approximately equal to one of a set of predetermined thicknesses.

12. The DOE according to claim 11, wherein an anti-reflection coating is formed on the first surface of the substrate.

13. The DOE according to claim 11, wherein the non-rectangular pixels of the diffractive structure are congruent to one another.

14. The DOE according to claim 13, wherein each of the non-rectangular pixels of the diffractive structure is one of a parallelogram, a triangle, or a hexagon.

15. The DOE according to claim 11, wherein:
the DOE is adapted to be used with a light having a predetermined wavelength of light;
the set of predetermined thicknesses includes a smallest thickness and a largest thickness; and
a difference between the smallest thickness and the largest thickness is less than the predetermined wavelength of light divided by a sum of the the photoresist index of refraction and negative one.

16. A laser writing system with non-orthogonal axes for laser machining a workpiece, comprising:
a laser source to generate a laser beam;
coupling optics to couple laser light to a beam spot on the workpiece;
a workpiece holder to hold the workpiece; and
positioning means coupled to the workpiece holder to scan the beam spot over the workpiece, the positioning means including an X translation stage to move the workpiece holder along an X axis and a Y translation stage to move the workpiece holder along a Y axis;
wherein:
the X axis and the Y axis are substantially orthogonal to a direction of propagation of the laser beam at the beam spot;
the X axis is not parallel to the Y axis; and
the X axis is not perpendicular to the Y axis.

17. The laser writing system according to claim 16, wherein the laser source includes a fluence controller to control a fluence of the laser beam as the beam spot is scanned over the workpiece.

18. The laser writing system according to claim 16, wherein the coupling optics focus the laser light at the beam spot on the workpiece.

19. The laser writing system according to claim 16, wherein the positioning means further includes a rotation stage coupled between the X translation stage and the Y translation stage to vary an angle between the X axis and the Y axis.

20. The laser writing system according to claim 16, wherein the positioning means further includes a Z translation stage for moving the workpiece holder along the Z axis to focus the beam spot on the workpiece.

21. A laser writing system with non-orthogonal axes for laser machining a workpiece, comprising:
a laser source to generate a laser beam;
coupling optics to couple laser light to a beam spot on the workpiece;
scanning optics to scan the beam spot on the workpiece along an X axis;
a workpiece holder to hold the workpiece; and
a Y translation stage coupled to the workpiece holder to move the workpiece holder along a Y axis;
wherein:
the X axis and the Y axis are substantially orthogonal to a direction of propagation of the laser beam at the beam spot;
the X axis is not parallel to the Y axis; and
the X axis is not perpendicular to the Y axis.

22. The laser writing system according to claim 21, wherein the laser source includes a fluence controller to control a fluence of the laser beam as the beam spot is scanned over the workpiece.

23. The laser writing system according to claim 21, wherein the coupling optics focus the laser light at the beam spot on the workpiece.

24. The laser writing system according to claim 21, further comprising a rotation stage coupled to the Y translation stage to vary an angle between the X axis and the Y axis.

25. The laser writing system according to claim 21, further comprising a Z translation stage coupled to the workpiece holder to move the workpiece holder along the Z axis to focus the beam spot on the workpiece.

26. A method for manufacturing a diffractive optical element (DOE) having a predetermined pattern of parallelogram-shaped pixels, using a laser writing system with non-orthogonal X and Y axes, the method comprising the steps of:
a) mounting a DOE workpiece in a workpiece holder of the laser writing system;
b) generating a laser beam using a laser source of the laser writing system;
c) directing the laser beam to a beam spot on a surface of the DOE workpiece using optics of the laser writing system;
d) scanning the beam spot across a functional area of the surface of the DOE workpiece along the X axis;
e) moving the workpiece holder of the laser writing system using a Y translation stage of the laser writing system such that the beam spot is stepped along the Y axis, wherein the X axis and the Y axis are substantially orthogonal to a direction of propagation of the laser beam at the beam spot, the Y axis is not parallel to the X axis, and the Y axis is not perpendicular to the X axis;
f) modulating a fluence of the laser beam at the beam spot as the beam spot is scanned to form the predetermined pattern of parallelogram-shaped pixels of the DOE in the functional area on the surface of the DOE workpiece; and
g) repeating steps (d), (e), and (f) until the beam spot has been scanned over the entire functional area on the surface of the DOE workpiece.

27. The method according to claim 26, wherein step (a) includes the steps of:
a1) mounting the DOE workpiece in the workpiece holder such that a predetermined scan line the DOE workpiece is substantially aligned to the X axis; and
a2) rotating a rotation stage coupled to the Y translation stage of the laser writing system to orient the Y axis at a predetermined angle relative to the X axis.

28. The method according to claim 26, wherein:
the laser source of the laser writing system is a pulsed laser source;
step (b) includes generating a pulsed laser beam using the pulsed laser source; and
step (d) includes stepping the beam spot across the functional area of the surface of the DOE workpiece along the X axis such that the beam spot is substantially motionless relative to the surface of the DOE workpiece during each pulse of the pulsed laser beam.

29. The method according to claim 26, wherein step (c) includes the steps of:
c1) directing the laser beam to the beam spot on the surface of the DOE workpiece using the optics; and
c2) focusing the laser beam using the optics such that the beam spot has a predetermined diameter.

30. The method according to claim 26, wherein step (c) includes the steps of:
c1) directing the laser beam to the beam spot on the surface of the DOE workpiece using the optics; and
c2) shaping a cross section of the laser beam using the optics such that the beam spot has a predetermined shape.

31. The method according to claim 26, wherein step (d) includes continuously scanning the beam spot across the functional area of the surface of the DOE workpiece along the X axis.

32. The method according to claim 26, wherein step (d) includes at least one of:
moving the workpiece holder of the laser writing system using an X translation stage of the laser writing system such that the beam spot is scanned across the functional area of the surface of the DOE workpiece along the X axis; or
moving the beam spot using scanning optics of the laser writing system such that the beam spot is scanned across the functional area of the surface of the DOE workpiece along the X axis.

33. The method according to claim 26, wherein:
the laser source of the laser writing system is a continuous wave (CW) laser source;
step (b) includes generating a CW laser beam using the CW laser source; and
the fluence of the CW laser beam at the beam spot is modulated in step (f) by at least one of:
varying a power of the CW laser beam; or
varying a scan speed along the X axis.

34. The method according to claim 26, wherein:
the laser source of the laser writing system is a pulsed laser source;
step (b) includes generating a pulsed laser beam using the pulsed laser source; and
the fluence of the pulsed laser beam at the beam spot is modulated in step (f) by at least one of:
varying a pulse power of the laser beam;
varying a scan speed along the X axis; or
varying a step time along the X axis.

35. The method according to claim 26, wherein the predetermined pattern of parallelogram-shaped pixels of the DOE is formed in the functional area on the surface of the DOE workpiece step (f) by one of:
ablating of material of the DOE workpiece;
depositing material on the surface of the DOE workpiece using a laser assisted chemical vapor deposition process; or
changing a refractive index of material of the DOE workpiece.

36. The method according to claim 26, wherein:
step (a) includes the steps of:
a1) forming a photoresist layer on the surface of the DOE workpiece; and
a2) mounting the DOE workpiece in the workpiece holder; and
step (f) includes the steps of:
f1) modulating the fluence of the laser beam at the beam spot as the beam spot is scanned to expose a pattern of parallelogram-shaped pixels in the photoresist layer; and
f2) developing the photoresist layer to form the predetermined pattern of parallelogram-shaped pixels of the DOE in the photoresist layer.

37. The method according to claim 26, wherein:
step (a) includes the steps of:
a1) forming a photoresist layer on the surface of the DOE workpiece; and
a2) mounting the DOE workpiece in the workpiece holder; and
step (f) includes the steps of:
f1) modulating the fluence of the laser beam at the beam spot as the beam spot is scanned to expose a pattern of parallelogram-shaped pixels in the photoresist layer;
f2) developing the photoresist layer to form a scaled pattern of parallelogram-shaped pixels in the photoresist layer;
f3) etching the photoresist layer and material of the DOE workpiece to transfer the scaled pattern of parallelogram-shaped pixels from the photoresist layer to the material of the DOE workpiece, forming the predetermined pattern of parallelogram-shaped pixels of the DOE in the functional area on the surface of the DOE workpiece.
